(19) United States
(12) Patent Application Publication
(10) Pub. No.: US 2006/0004552 A1
(43) Pub. Date: Jan. 5, 2006

(54) Boundary element analytic method and a boundary element analytic program

(75) Inventors: Keisuke Hayabusa, Fujisawa-shi (JP); Kenji Amaya, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: EBARA CORPORATION, Tokyo (JP); KENJI AMAYA, Kawasaki-shi (JP)

(21) Appl. No.: 11/165,469

(22) Filed: Jun. 24, 2005

(30) Foreign Application Priority Data
Jun. 30, 2004 (JP) 2004-193329

(51) Int. Cl. G06F 17/10

(52) U.S. Cl. 703/2; 700/98

(57) ABSTRACT

An object of the present invention is to provide a boundary element analytic method and a boundary element analytic program, which are capable of coping with the problem of diversity in symmetric property to be encountered when carrying out an analytic operation by taking advantage of the symmetric property of a subject to be analyzed, and thus providing an efficient analysis.

Various types of data for the use in the boundary element analysis, which have been previously input at step S101, are stored at step S102. To carry out this operation, at least boundary element definition information for defining a boundary element in the subject to be analyzed and state quantity information in which boundary element identification information for identifying the defined boundary element is associated with the boundary element for each state quantity thereof. At step 103, the input different types of data are used to generate a digitized boundary integral equation with a boundary value at a point of element on each defined boundary element taken as a variable. Then, at step S104, the generated boundary integral equation is assigned with the input boundary condition to sort out any unknowns, thus obtaining the simultaneous equations. The obtained simultaneous equations are then solved to determine respective values for the unknowns.

### BACKGROUND OF THE INVENTION

The present invention relates to a boundary element analytic method and a boundary element analytic program for performing a boundary element analysis by using a computer.

Rapid advancement in ability of a computing machine has developed an active trend for replacing an experiment which has conventionally relied on a model or an actual equipment with a simulation by way of numerical analytic techniques. In conjunction with this, a required scale and speed of analysis is increasing continuously at a rate exceedingly greater than that in the advancement of the computing machine.

Among many types of numerical analytic technique, a boundary element method is advantageously applicable in the analysis of a stress field, an electric field, a magnetic field, a corrosive field and the like and has so far introduced in a variety of applications. In accordance with a typical manner of the boundary element method, a governing equation may be transformed to a boundary integral equation. That is, a digitized boundary integral equation, such as the following [Eq. 1], may be given, in which a boundary is digitized into a plurality of discrete elements with a boundary value at a point of element on each discrete element taken as a variable.
k[H]{u}=[G]{q} [Eq. 1]

In the above expression, the [H] and the [G] denote matrixes that are determined in dependence on the geometrical and material conditions in the analytic field. Additionally, the {u} and the {q} represent boundary values. For example, in analyzing a stress, the {u} denotes a displacement and the {q} denotes a surface force, while in analyzing an electric field, the {u} denotes a potential and the {q} denotes a current density.

If the boundary conditions are assigned to the [Eq. 1] and any unknowns are sorted out, then such a simultaneous equations as the following [Eq. 2] is given.
[A]{x}={b} [Eq. 2]

In the above expression, the {x} and the {b} denote an unknown vector and a constant vector, respectively. A number of unknowns corresponds to the number of points of element. In order to perform the analysis of a real complex structure and the like pertained with an extremely large fluctuation both geometrically and materially, a huge number of elements should be necessary, and consequently the number of unknowns should be also huge in the analyzing process in such a large scale.

Generally, there are not a few industrial products and/or structures of different types to be analyzed, which are characterized in the symmetric property in geometry and boundary condition. If the given problem is of the problem of symmetrical structure, then an efficient digitization could be realized by taking advantage of the symmetric property. In this regard, the problem of symmetry refers to such a problem including the existence of an axis of symmetry or a plane of symmetry involved in the geometry and the boundary condition of the object. In the light of the fact that the boundary values for the points of elements located symmetrically are identical, if this symmetric property is advantageously used in performing the numerical analysis, the number of unknowns could be significantly reduced.

Some approaches may be found, for example, in the following Patent Document 1 and Non-patent Document 1, in which the subject to be analyzed is processed into a model by taking the symmetric property thereof into account for the purpose of high efficiency in the boundary element analysis.

However, the problem of symmetry could be of diversity, since the symmetry includes wide variations such as plane symmetry, inverse symmetry, axial symmetry, helical symmetry, short cake symmetry and any complex forms thereof. Since the symmetric property is diversely defined, where the generation method of a mirror image and the required number of mirror images to be generated are different in dependence on each individual type of symmetry, each specific program must be configured for every different type of symmetry. Furthermore, some of the actual subjects to be analyzed include a number of different types of symmetry in a mixed manner, and in additional consideration for the problem of the mixture of different types of symmetry, the number of cases to be coped with should be expansively increased, leading to a serious matter in maintenance and extendability of the program.
[Patent Document 1]

Japanese Patent Laid-open Publication No. Hei 9-251481
[Non-patent Document 1]

“Material and Environment”, Vol. 47, No. 3, P. 156-163 (1988)

### SUMMERY OF THE INVENTION

The present invention has been made in the light of the above circumstances, and an object thereof is to provide a boundary element analytic method and a boundary element analytic program which are capable of coping with the problem of diversity in symmetry property to be encountered when carrying out an analytic operation by taking advantage of the symmetric property of a subject to be analyzed and thus providing an efficient analysis.

A boundary element analytic method of the present invention is provided as an inventive method for performing boundary element analysis by using a computer, comprising: a data input step for inputting data to be used in the boundary element analysis; a data storage step for storing said data input in the data input step; an equation generation step for generating a digitized boundary integral equation based on the data stored in the data storage step; and a data analyzing step for arithmetically determining unknowns in the boundary integral equation, after the boundary integral equation having been assigned with a boundary condition input in the data input step, wherein the data storage step serves to store at least boundary element definition information for defining a boundary element in a subject to be analyzed and state quantity information in which with a state quantity of the boundary element is associated boundary element identification information for identifying one or more of the boundary elements having the state quantity, and wherein the equation generation step serves to generate the boundary integral equation having a specific number of said state quantity defined in the state quantity information.

According to the present invention, the boundary integral equation with the reduced number of unknowns can be generated easily, and thus the volume of arithmetic operation required to determine those unknowns can be reduced. Further, the method of the present invention can cope with the problem of diversity in symmetry in the subject to be analyzed and provide an efficient analysis.

According to the boundary element analytic method of the present invention, said equation generation step includes: a step of executing an arithmetic operation for calculating a sum of coefficient values determined in dependence on a geometry of the subject to be analyzed with reference to the boundary element definition information and the state quantity information, when the boundary element having the boundary element identification information “i” is taken as a source point (i=1 to L, where the L represents the total number of the source points and is an arbitrary number not smaller than the number of the state quantity information “Ng” but not greater than the number of the defined boundary elements) and each of the boundary elements associated with the state quantity identification information “k” (k=1 to Ng) for identifying each state quantity in the state quantity information is taken as an observation point; and a step for generating a coefficient matrix of L-rows and Ng-columns with the determined sums taken as the coefficient value of ith-row and kth-column, wherein the coefficient matrix of L-rows and Ng-columns is taken as the coefficient matrix in the boundary integral equation.

According to the present invention, the coefficient values of the coefficient matrix in the boundary integral equation can be determined by repeating the similar arithmetic operations with reference to the stored boundary element definition information and the state quantity information, and so the analytic operations can be carried out in an efficient manner.

It should be noted that the boundary integral equation having the coefficient values that have been determined in the above processing may be expressed as such in the following [Eq. 3], if described without using the matrix expression. In this form of expression, “L” denotes the number of elements whose source points should be scanned (i.e., a subset of elements), “Ng” denotes the total number of state quantity, “Sk” denotes the collection of boundary elements having the state quantity “k”, and u* and q* represent the term of state quantity for a potential and a flux, respectively.

$$K {\sum }_{k = 1}^{{N}_{g}} ( {\sum }_{j ∈ {S}_{k}} {h}_{ij} ) {u}_{k}^{*} = {\sum }_{k = 1}^{{N}_{g}} ( {\sum }_{j ∈ {S}_{k}} {g}_{ij} ) {q}_{k}^{*} \qquad [ Eq . 3 ]$$

A boundary element analytic program of the present invention is provided as a program for executing respective steps in the boundary element analytic method as described above by using a computer.

As obvious from the above description, according to the present invention, it becomes possible to provide a boundary element analytic method and a boundary element analytic program, which are capable of coping with the problem of diversity in symmetry to be encountered in executing the analytic operation by taking advantage of the symmetric property of a subject to be analyzed and can provide an efficient analysis.

### BRIEF DESCRIPTION OF THE DRAWINGS

FIG. 1 is a diagram showing a general flow of a boundary element analytic method according to an embodiment of the present invention;

FIG. 2 is a diagram showing a general flow of a boundary integral equation generation process in a boundary element analytic method according to an embodiment of the present invention;

FIG. 3 is a diagram showing a general flow of a matrix coefficient generation process in a boundary element analytic method according to an embodiment of the present invention;

FIG. 4 is a diagram showing one example of data structure of input data in a boundary element analytic method according to an embodiment of the present invention;

FIG. 5 is a table in an exemplary form indicative of a set of state quantity information in a boundary element analytic method according to an embodiment of the present invention;

FIG. 6 is a table in an exemplary form indicative of a set of boundary element information in a boundary element analytic method according to an embodiment of the present invention;

FIG. 7 is a table in an exemplary form indicative of a set of node information in a boundary element analytic method according to an embodiment of the present invention;

FIG. 8 represents an exemplary form indicative of a subject to be analyzed;

FIG. 9 is a table in an exemplary form indicative of a set of state quantity information of the subject to be analyzed shown in FIG. 8;

FIG. 10 is a table in an exemplary form indicative of a set of boundary element information of the subject to be analyzed shown in FIG. 8;

FIG. 11 is a table in an exemplary form indicative of a set of node information of the subject to be analyzed shown in FIG. 8; and

FIG. 12 is a diagram illustrating an exemplary storage processing of the boundary element defining information and the state quantity information in the boundary element analytic method according to an embodiment of the present invention.

### DETAILED DESCRIPTION OF THE INVENTION

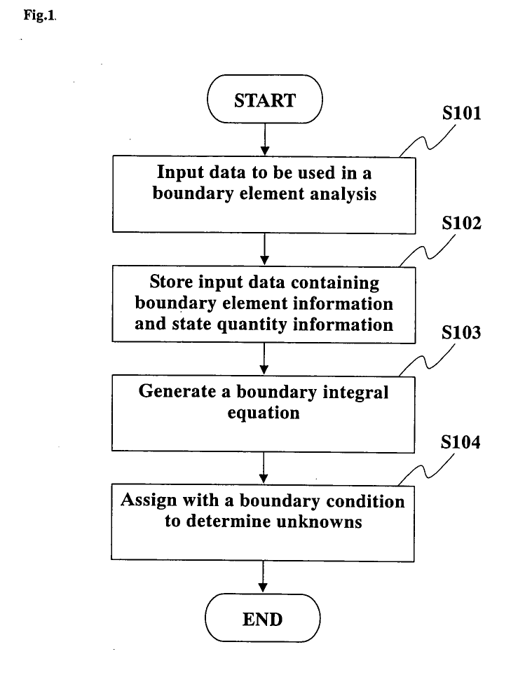

Preferred embodiments of the present invention will now be described with reference to the attached drawings. With reference to FIG. 1, there is shown a general flow of a boundary element analytic method according to an embodiment of the present invention. Respective steps shown in FIG. 1 are executed by a computer in which a predetermined program has been installed. It should be noted that the computer used therein may be a stand-alone computer or a computer of client-server type, and may require no special peripheral devices or functions to be added. Therefore, the present invention may use any ordinary computer and no detailed description of the configuration of the computer should be herein provided.

At step S101, various types of data to be used in the boundary element analysis are input. Those types of data to be input include information on a node for defining a boundary element, information on the boundary element containing information for identifying the node defining each discrete boundary element, information on a state quantity associated with each discrete boundary element, a boundary condition, constant data unique to an individual subject to be analyzed and a function representing a relation among respective variables of the subject to be analyzed (including the state quantity).

At step S102, those various types of data input previously at step S101 are stored. This step stores at least boundary element definition information for defining the boundary element in the subject to be analyzed and state quantity information in which boundary element identification information for identifying the defined boundary element is associated with the boundary element for each state quantity thereof. The content, format of the data to be stored will be described later.

At step S103, taking advantage of the various types of input data, a digitized boundary integral equation is generated with a boundary value at a point of element on each defined boundary element taken as a variable. The boundary integral equation generated at this step includes a certain number of state quantities defined in the state quantity information as variables. The detailed description of the generation method thereof will be given later.

At step S104, the generated boundary integral equation is assigned with the input boundary condition to sort out any unknowns, thus obtaining simultaneous equations. Then, the obtained simultaneous equations are solved to determine respective values for the unknowns. Since the processing in this step S104 is similar to that of the conventional boundary element analysis, the further description should be herein omitted. However, it is to be understood that in the conventional analytic method with no symmetric property of the subject to be analyzed taken into account, the number of the state quantities included in the generated boundary integral equations is equal to that of the defined boundary element, while on the contrary, in the analytic method of this embodiment, it is equal to the number of the defined state quantities, and so it can help reduce the volume of required arithmetic operation significantly.

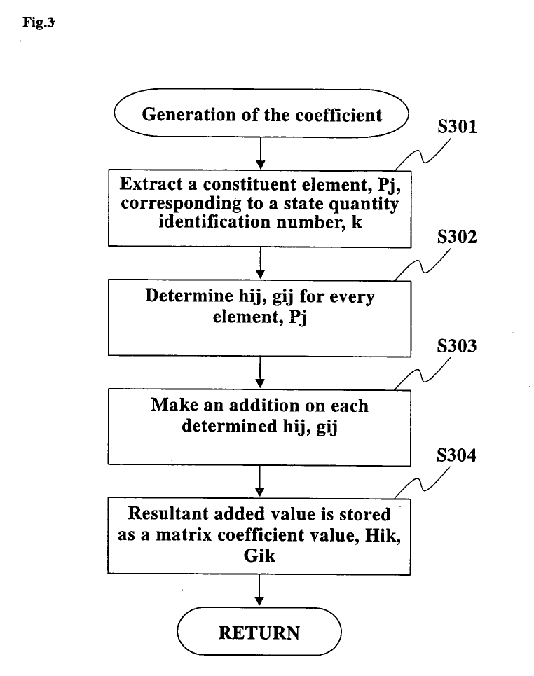

The content and format of the data stored in step S102 of FIG. 1 will now be described. FIG. 4 presents an example of a data structure of the input data used in the boundary element analytic method of the illustrated embodiment. As shown in FIG. 4, the quantity indicated by the boundary value and its associated function is defined as the state quantity. Then, the state quantity identification information for identifying the defined state quantity (i.e., state quantity ID) is associated with the boundary condition and the boundary element having the defined state quantity (i.e., constituent element) to constitute the state quantity information 1, which is in turn stored.

The boundary element is defined by boundary element identification information for identifying each discrete boundary element (i.e., element ID), a node constituting the boundary element (i.e., constituent node) and a geometry of the boundary element, all of which are stored collectively as the boundary element information 2. Further, the node is associated with node identification information for identifying each discrete node (i.e., node ID) and its coordinate, both of which are stored collectively as the node information 3. Accordingly, the geometry data on the boundary element can be recognized by the boundary element information 2 and the node information 3.

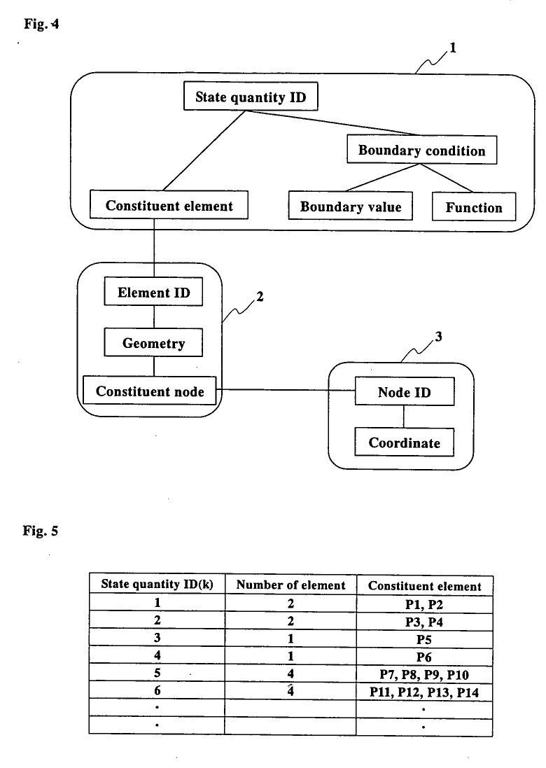

FIG. 5 shows an example of the state quantity information. FIG. 5 only indicates the relationship between the state quantity ID and the constituent element, and the relationship is presented in the form of table containing the state quantity ID (indicated by the state quantity identification number “k” in this example), the number of the elements and the constituent element(s), which are associated with one another. It should be noted in FIG. 5 that the number of elements means the number of the constituent elements having the specific state quantity ID, wherein the P1, P2 and so on described in term of the constituent element represents the element ID.

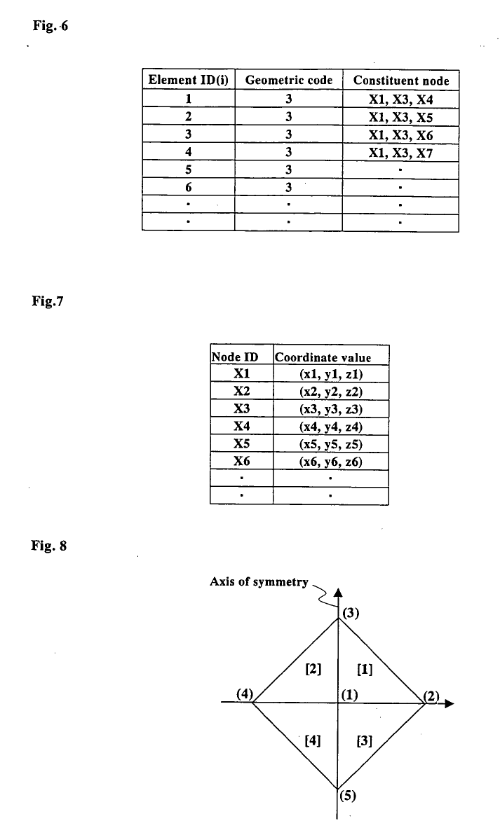

FIG. 6 shows an example of the boundary element information. The boundary element information of FIG. 6 is presented in the form of table containing the element ID (i.e., the boundary element identification number “i” in this example), the geometry code and the constituent node, which are associated with one another. It should be noted that the geometry code designates the geometry of the boundary element. The geometry code may be defined such that 1 represents a point element, 2 a line element, 3 a triangular element and 4 a rectangular element. Further, the X1, X2 and so on described in term of the constituent node represent the node ID.

FIG. 7 shows an example of the node information. The node information of FIG. 7 is presented in the form of table containing the node ID and its associated coordinate value.

It should be noted that the storing of the input data may be input in the data structure as described above, but alternatively, the input data may be once stored and then the processing for changing the data structure may be additionally executed. For example, similarly to the conventional practice, the data set in the structure containing the boundary condition information and its associated geometry information for each element may be input first, and then pieces of information having the identical boundary value (state quantity) may be collected together to thereby create the above described set of state quantity information.

To store the boundary element definition information and the state quantity information on an analytic subject in a column configuration having an axial symmetric distribution as shown in FIG. 12, for example, the following procedure may be taken. It is herein assumed that the state quantity values in this subject to be analyzed are identical in the circumferential direction and are distributed in the axial direction. Firstly, the element breakdown is applied to a partial subject as shown in FIG. 12(a) that has been segmented in the axial direction to give an element number for each element. Secondly, the set of elements represented in FIG. 12(a) is rotated and copied several times to obtain sets of boundary elements representing the entire subject to be analyzed, as shown in FIG. 12(b). Since the boundary elements should have been defined by the identical element numbers and the identical node numbers among the sets of boundary elements at this operation, the data on the node coordinates and the like may be stored for each partial subject to be analyzed. Such operations may be carried out by using a general-purpose element breakdown software.

Then, every set of generated data is read, and the nodes defined by the same coordinate are sorted into a group, to which a node ID is given in a serial number throughout all of the groups. Based on the fact that in the boundary elements that have been stored for each partial subject to be analyzed, the element having the same element number has the same state quantity, those having the same element number are sorted in a group, on which the state quantity is defined, and the state quantity is in turn associated with a plurality of boundary elements, all of which operations are repeated for every boundary element. Finally, every boundary element is reassigned with the element ID in the serial number throughout the entire subject to be analyzed.

FIG. 12 (c) shows the entire subject to be analyzed, where each boundary element has been reassigned with the serial element ID. Since those boundary elements defined by the element IDs 1 to 16 have the identical state quantity (the state quantity 1), and those boundary elements defined by the element IDs 17 to 32 have the identical state quantity (the state quantity 2), therefore the state quantity 1 is associated with the boundary elements having the IDs 1 to 16, and the state quantity 2 is associated with the boundary elements having the IDs 17 to 32, thus generating the state quantity information, which is in turn stored. Further, the boundary element ID is associated with the node ID, and the node ID is associated with the node coordinate, thus to generate the boundary element definition information, which is in turn stored.

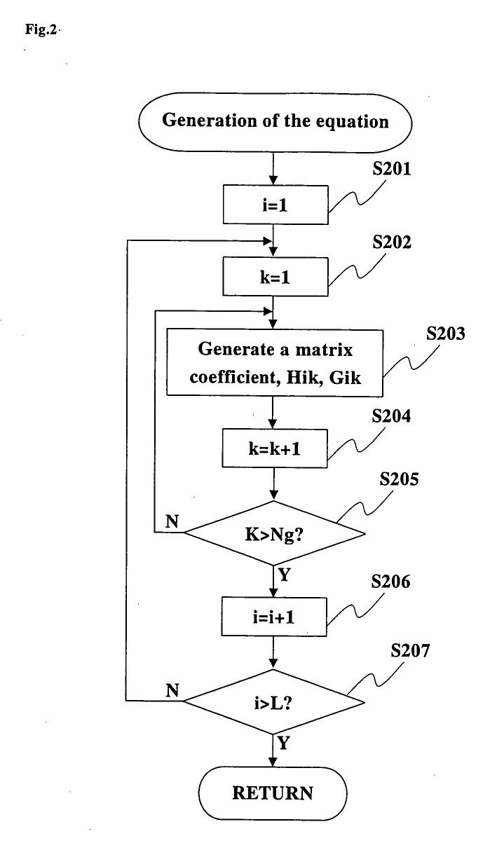

The description will now be directed to the generation of the boundary integral equation, which is shown in step S103 of FIG. 1. FIG. 2 shows a general flow of the boundary integral equation generation process.

At step S201, the boundary element identification number “i” is initialized, while at step S202, the state quantity identification number “k” is initialized. The default value is “1” for both numbers. Then, at step S203, the matrix coefficient Hᵢₖ, Gᵢₖ is generated. The matrix coefficients Hᵢₖ and Gᵢₖ are the values for respective elements in the coefficient matrix [H] and [G], respectively, of the digitized boundary integral equation expressed in the following [Eq. 4]
k[H]{u*}=[G]{q*} [Eq. 4]

FIG. 3 shows a general flow of the matrix coefficient generation process. At step S301, the constituent element “Pⱼ” stored in association with the state quantity identification number “k” is extracted with reference to the state quantity information. For example, if k=1 in the example shown in FIG. 5, the constituent elements P₁ and P₂ are extracted. In this regard, the boundary element identification numbers “i” of the constituent elements P₁ and P₂ are 1 and 2, respectively.

At step S302, the coefficient values “hij” and “gij” are calculated for every one of Pⱼ in the case of the boundary element Pᵢ having the boundary element identification information “i” is taken as a source point and the boundary element Pⱼ is taken as an observation point. The coefficient values hij and gij are the coefficients determined in dependence on the geometry of the subject to be analyzed as well as the field for the subject to be analyzed, and may be determined by using the boundary element information. For example, since the constituent elements P₁ and P₂ are extracted in case of the condition of k=1 in the example shown in FIG. 5, if i=1, then the coefficient values h₁₁, g₁₁, h₁₂ and g₁₂ are derived.

At step S303, an addition is applied to each of the determined coefficient values hᵢⱼ and gᵢⱼ. For example, assuming that the coefficient values h₁₁, g₁₁, h₁₂ and g₁₂ have been derived, then the additions h₁₁+h₁₂ and g₁₁+g₁₂ are executed for the solutions. Then, at step S304, the resultant values from the above additions are stored as the matrix coefficients Hᵢₖ and Gᵢₖ.

Turning back to FIG. 2, once the matrix coefficients Hᵢₖ and Gᵢₖ have been generated at step S203, the k is incremented by +1 (step S204) and it is determined whether or not k>Ng (step S205). If not k>Ng, step S203 is executed repeatedly. In this concern, since the Ng represents the number of the stored state quantity information, the matrix coefficients Hᵢₖ and Gᵢₖ by any numbers equivalent to the numbers of the defined state quantity are generated.

If step S205 determines k>Ng, the “i” is incremented by +1 (step S206) and it is determined whether or not i>L (step S207). Then, if not i>L, the operations subsequent to step S202 are executed repeatedly. In this concern, the L may be any number that is not smaller than the number of state quantity Ng but not greater than the number of the defined boundary element. In the arithmetic operation for the simultaneous equations in step S104 of FIG. 1, since the solution could be found if at least Ng sets of equations are anyhow given, L=Ng should work out sufficiently. Obtaining the solution by using the least-square method under the condition of L>Ng can improve the accuracy, as well. It is also contemplated that the source points are scanned with respect to the boundary elements having the same state quantity to calculate the matrix coefficients, respectively, and in that case the averaged value over the calculated coefficients may be taken as the matrix coefficient for the boundary integral equation, which can also help improve the accuracy.

It should be noted that although in this example the boundary element identification number “i” has been selected serially from 1 to L upon taking the L pieces of boundary element as the source points, the number of boundary elements to be selected is not limited to L but may be determined arbitrarily. For example, when one half of the number of the boundary elements are taken as the source points, then boundary elements having the boundary element identification number “i” defined by every other numeral may be selected. As apparent from the above description, the boundary integral equation having the coefficient values determined in the above described process may be expressed as such that has been given in the [Eq. 3], if it is not expressed in the matrix form.

The boundary integral equation generated in the above-described procedure has the coefficient matrix of L-rows and Ng-columns. Whatever the symmetric property of the analytic subject may be, the boundary integral equation with the reduced number of state quantity can be easily generated.

The generation process of the boundary integral equation will now be described in accordance with a specific example. FIG. 8 shows one example of a subject to be analyzed, which is composed of four boundary elements [1] to [4]. The subject to be analyzed shown in FIG. 8 has each two boundary elements [1] and [3] and elements [2] and [4] on either side with respect to an axis of symmetry, wherein the boundary elements [1] and [2] and the boundary elements [3] and [4] have the equivalent state quantity, respectively.

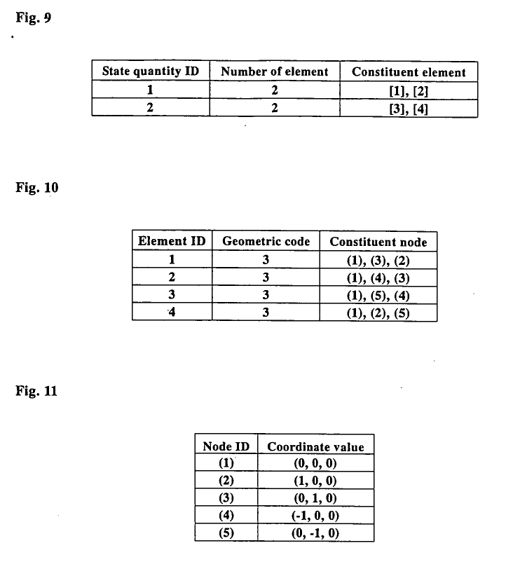

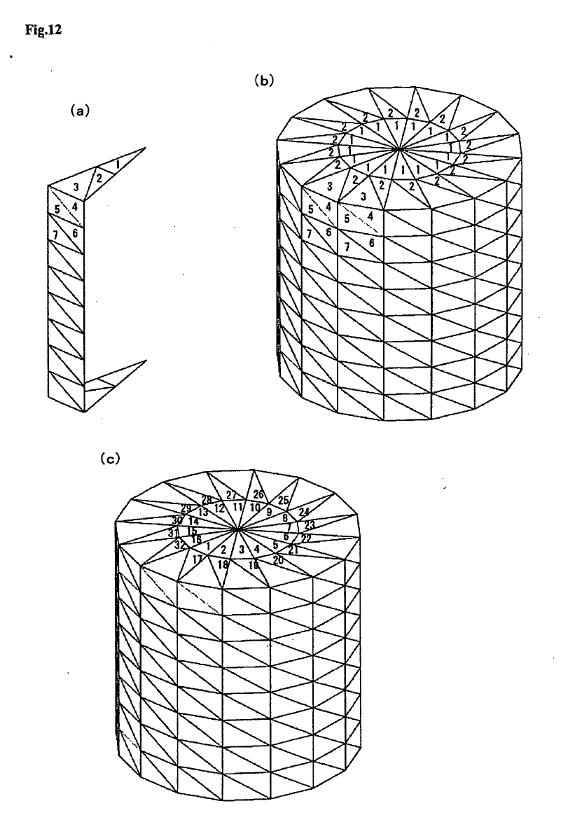

If the analytic subject is such as shown in FIG. 8, the state quantity information, the boundary element information and the node information to be stored are expressed in the forms as shown in FIG. 9, FIG. 10 and FIG. 11, respectively.

Assuming herein that the state quantity for the element identified by the state quantity ID “1” is represented by u1, q1, the state quantity for the element identified by the state quantity ID “2” is represented by u2, q2, and the element IDs for the boundary elements taken as the source points are “1” and “3”, if the processing in accordance with the flows shown in FIG. 2 and FIG. 3 is carried out, the boundary integral equation with the coefficient matrix of 2×2 as shown below may be obtained.

That is, the matrix coefficient values when i=1, k=1 are h₁₁+h₁₂ and g₁₁+g₁₂, and the matrix coefficient values when i=1, k=2 are h₁₃+h₁₄ and g₁₃+g₁₄. Further, the matrix coefficient values when i=3, k=1 are h₃₁+h₃₂ and g₃₁+g₃₂, and the matrix coefficient values when i=3, k=2 are h₃₃+h₃₄ and g₃₃+g₃₄. Therefore, the boundary integral equation to be generated is such as shown below in [Eq. 5].

$$κ [ \begin{matrix}{h}_{11} + {h}_{12} & {h}_{13} + {h}_{14} \\ {h}_{31} + {h}_{32} & {h}_{33} + {h}_{34}\end{matrix} ] \{ \begin{matrix}{u}_{1}^{*} \\ {u}_{2}^{*}\end{matrix} \} = [ \begin{matrix}{g}_{11} + {g}_{12} & {g}_{13} + {g}_{14} \\ {g}_{31} + {g}_{32} & {g}_{33} + {g}_{34}\end{matrix} ] \{ \begin{matrix}{q}_{1}^{*} \\ {q}_{2}^{*}\end{matrix} \} \qquad [ Eq . 5 ]$$

What is claimed is:

1. A boundary element analytic method for performing a boundary element analysis by using a computer, comprising:
a data input step for inputting data to be used in said boundary element analysis;
a data storage step for storing said data input in said data input step;
an equation generation step for generating a digitized boundary integral equation based on said data stored in said data storage step; and
a analyzing step for arithmetically determining unknowns in said boundary integral equation, after said boundary integral equation having been assigned with a boundary condition input in said data input step, wherein
said data storage step serves to store at least boundary element definition information for defining a boundary element in a subject to be analyzed and state quantity information in which with a state quantity of said boundary element is associated boundary element identification information for identifying one or more of said boundary elements having said state quantity, and
said equation generation step serves to generate said boundary integral equation having a specific number of said state quantity defined in said state quantity information.

2. A boundary element analytic method in accordance with claim 1, in which said equation generation step includes:
a step of executing an arithmetic operation for calculating a sum of coefficient values determined in dependence on geometry of the subject to be analyzed with reference to said boundary element definition information and said state quantity information, in the case of the boundary element having the boundary element identification information “i” is taken as a source point (i=1 to L, where the L represents the total number of the source points and is an arbitrary number not smaller than the number of said state quantity information, Ng, but not greater than the number of the defined boundary elements) and each of the boundary elements associated with the state quantity identification information k (k=1 to Ng) for identifying each state quantity in said state quantity information is taken as an observation point; and
a step of generating a coefficient matrix of L-rows and Ng-columns with said determined sums taken as the coefficient value of ith-row and kth-column, wherein
said coefficient matrix of L-rows and Ng-columns is taken as the coefficient matrix in said boundary integral equation.

3. A computer program product of a boundary element analysis for executing respective steps in a boundary element analytic method in accordance with claim 1 by using a computer.

4. A computer program product of a boundary element analysis for executing respective steps in a boundary element analytic method in accordance with claim 2 by using a computer.
